(19) United States
(12) Patent Application Publication
(10) Pub. No.: US 2021/0048278 A1
(43) Pub. Date: Feb. 18, 2021

(54) Active Shooter Response System

(71) Applicant: GREGORY SYLVESTER CAMPBELL, MIRAMAR, FL (US)

(72) Inventor: GREGORY SYLVESTER CAMPBELL, MIRAMAR, FL (US)

(21) Appl. No.: 16/540,935

(22) Filed: Aug. 14, 2019

(51) Int. Cl. F41H 13/00; F41H 9/04; B64C 39/02; B64D 47/08; H01Q 1/28; H04W 4/90

(52) U.S. Cl. CPC F41H 13/00; F41H 9/04; F41H 13/0006; B64C 39/024; B64D 47/08; H01Q 1/36; H04W 4/90; B64C 2201/027; B64C 2201/146; B64C 2201/127; H01Q 1/28

(57) ABSTRACT

A unmanned aerial vehicle piloted by remote control with onboard computers a camera equipped with object recognition software to detect guns which will launch the unmanned aerial vehicle into the air then transmit live video feed to two small spring loaded cannons mounted on each side of the unmanned aerial vehicle the cannons launch at the target one at a time the heavy net containing weights at the target. A high pressure hose system connected to a containing tank mounted on the unmanned aerial vehicle the tank contains pepper spray which is exited through the high pressure hose at the target. Live video is sent using the Internet and cloud computing technology to the Emergency Alert System which transmit the video to many different electronic devices examples: smart phone laptop or desktop computer IPad and computer tablet.

This invention relates to an unmanned aerial vehicle piloted by remote control with onboard computers a camera equipped with object recognition software to detect guns once the guns are detected the unmanned aerial vehicle is launch into the air to fire two small cannons one at a time at the target the cannons contains a heavy net with weights after the net hits the target the unmanned aerial vehicle flies to the target and pepper sprays the target using two high pressure hose system connected to a containing tank that releases the pepper spray on the target.

The unmanned aerial vehicle sends real time video feed of the target in the net to the Emergency Alert System using the Internet with cloud computing technology which sends that real time video feed to many different electronic devices example: smartphone, laptop or desktop computer IPad or computer tablet. Now you can track the location of the target with real time video feed using the Emergency Alert System.

1. An unmanned aerial vehicle piloted by remote control with onboard computers a ground based controller of systems communications between the two.

2. An unmanned aerial vehicle piloted by remote control according to claim 1. A camera with object recognition software and thermal capabilities for night vision to detect a gun and transmit real time video feed to the Emergency Alert System.

3. An unmanned aerial vehicle piloted by remote control according to claim 1. A hierarchical control system governing software and hardware implemented by a computer network.

4. GPS navigation

5. An unmanned aerial vehicle piloted by remote control according to claim 3. Visual search software with a patch or helical antenna to assist the detection location of any type of gun.

6. An unmanned aerial vehicle piloted by remote control according to claim 3. Two computers powered small cannons mounted on each side of the unmanned aerial vehicle loaded with heavy nets with weights to launch at the target.

7. An unmanned aerial vehicle piloted by remote control according to claim 3. Autonomous computer control system connected to the unmanned aerial vehicle to send real time video feed to the Emergency Alert System using the Internet and cloud computing transferring the video to smart phones laptop or desktop computers IPad or computer tablet.

8. An unmanned aerial vehicle piloted by remote control according to claim 1. A second unmanned aerial vehicle to work in tandem tracking and following the target.

9. An unmanned aerial vehicle piloted by remote control according to claim 3. A high pressure hose sprayer attached to the unmanned aerial vehicle with a containing tank loaded with pepper spray to release on the target.

10. An unmanned aerial vehicle piloted by remote control according to claim 3. The unmanned aerial vehicle launch begins with confirmation of a gun.
